(19) United States
(12) Patent Application Publication
(10) Pub. No.: US 2022/0234422 A1
(43) Pub. Date: Jul. 28, 2022

(54) VEHICLE COOLING SYSTEM

(71) Applicant: TOYOTA JIDOSHA KABUSHIKI KAISHA, Toyota-shi Aichi-ken (JP)

(72) Inventors: Kazuki Masumura, Toyota-shi Aichi-ken (JP); Masao Yorifuji, Toyota-shi (JP); Hidekazu Hirabayashi, Chiryu-shi Aichi-ken (JP); Rino Oshikiri, Toyota-shi (JP)

(21) Appl. No.: 17/573,834

(22) Filed: Jan. 12, 2022

(30) Foreign Application Priority Data
Jan. 26, 2021 (JP) 2021-010222

(51) Int. Cl. B60H 1/32; B60H 1/00

(52) U.S. Cl. CPC B60H 1/3205; B60H 1/00278; B60H 2001/3283; B60H 2001/3266; B60H 1/32284

(57) ABSTRACT

In the case where the temperature of a battery is equal to or higher than a predetermined temperature, the battery is cooled with priority. In the case where the temperature of coolant to cool a PCU is equal to or higher than another predetermined temperature, the PCU is cooled with priority. In the case where the temperature of the battery is less than the predetermined temperature and the temperature of the coolant to cool the PCU is less than the other predetermined temperature, the air inside the vehicle cabin is cooled with priority.

### CROSS REFERENCE TO RELATED APPLICATION

This application claims priority to Japanese Patent Application No. 2021-010222 filed on Jan. 26, 2021, which is incorporated herein by reference in its entirety including the specification, claims, drawings, and abstract.

### TECHNICAL FIELD

The present disclosure relates to a vehicle cooling system for cooling a running battery, a power control unit, and the air inside a vehicle cabin.

### BACKGROUND

For example, JP 2013-199251A discloses a vehicle cooling system known as a system for cooling a running battery (hereinafter referred to as a battery) and the air inside a vehicle cabin with an air conditioning system (an air conditioning operation) in a vehicle. Specifically, upon detection of a high battery cooling load, the vehicle cooling system decreases the cooling capability of the air conditioning system to thereby enhance cooling capability to cool the running battery.

Another known example of vehicle cooling systems is a system for cooling, for example, a battery and a power control unit (hereinafter abbreviated as PCU) and also for cooling the air inside a vehicle cabin with an air conditioning system. In this vehicle cooling system, a refrigeration cycle device circulates refrigerant to cool the battery and the air inside the vehicle cabin, while a cooling device circulates coolant to cool the PCU.

In the above-described vehicle cooling system, the radiator of the cooling device is disposed downstream, with respect to an airflow, from the condenser of the refrigeration cycle device to cool the radiator of the cooling device with the airflow having passed through the condenser of the refrigeration cycle device. With this disposition, for example, in the case where a compressor is driven at a high rotation speed to cool the battery with priority, the condensation temperature of the condenser becomes high, which leads to high temperature of the air having passed through the condenser. This decreases the cooling capability to cool the PCU.

In the above-described vehicle cooling system, an evaporating unit for cooling the battery and an evaporating unit for cooling the air inside the vehicle cabin are disposed parallel to each other, and a flow regulating valve adjusts the ratio in amount between the refrigerants passing through the respective evaporating units. Accordingly, increasing the amount of refrigerant circulating to cool the battery in order to cool the battery with priority leads to a decrease in the amount of refrigerant circulating to cool the vehicle cabin. This decreases the cooling capability to cool the vehicle cabin.

### SUMMARY

In other words, as cooling the battery, cooling the PCU, and cooling the air inside the vehicle cabin have a trade-off relationship in the above-described vehicle cooling system, it is desired to cool the battery, the PCU, and the air inside the vehicle cabin with favorable balance, depending on the situation.

In view of the above, an object of the present disclosure is to provide a vehicle cooling system that determines the level of priority in cooling a battery, a PCU, and the air inside a vehicle cabin, depending on the situation, to thereby cool the battery, the PCU, and the air inside the vehicle cabin with favorable balance.

According to one aspect of the present disclosure, there is provided a vehicle cooling system including a refrigeration cycle device having a first evaporating unit for cooling the running battery of a vehicle, a second evaporating unit connected parallel to the first evaporating unit, the second evaporating unit being for cooling the air inside a vehicle cabin, a regulating valve for adjusting the ratio in amount between the refrigerant passing through the first evaporating unit and the refrigerant passing through the second evaporating unit, and a condenser for being cooled with airflow; a cooling device for cooling the power control unit of the vehicle with coolant, the cooling device having a heat exchanger disposed downstream, with respect to the airflow, from the condenser, the heat exchanger being for cooling the coolant with the airflow; and a power control unit temperature estimation unit for estimating the temperature of the power control unit, wherein in the case where the temperature of the battery is equal to or higher a predetermined temperature, the battery is cooled with priority, in the case where the temperature of the power control unit, estimated by the power control unit temperature estimation unit, is equal to or higher than another predetermined temperature, the power control unit is cooled with priority, and in the case where the temperature of the battery is lower than the predetermined temperature, and the temperature of the power control unit, estimated by the power control unit temperature estimation unit, is less than the other predetermined temperature, the air inside the vehicle cabin is cooled with priority.

In the vehicle cooling system according to the present disclosure, in the case where the battery is cooled with priority, the amount of refrigerant circulating through the refrigeration cycle device may be increased, and the amount of refrigerant passing through the first evaporating unit may be increased with the regulating valve.

In the vehicle cooling system according to the present disclosure, in the case where the power control unit is cooled with priority, the amount of refrigerant passing through the condenser may be decreased to lower the temperature of the airflow having passed through the condenser.

In the vehicle cooling system according to the present disclosure, in the case where the air inside the vehicle cabin is cooled with priority, the amount of refrigerant circulating through the refrigeration cycle device may be increased and the amount of refrigerant passing through the second evaporating unit may be increased with the regulating valve.

According to a vehicle cooling system disclosed in the present disclosure, the level of priority in cooling the battery, the PCU, and the air inside the vehicle cabin is determined based on the temperature of the battery and the temperature of the coolant to cool the PCU. This arrangement makes it possible to prevent deceleration in the speed of the vehicle due to increased temperature of the battery and/or a decrease in the running capability of the vehicle due to restricted output attributed to excessive heating of the PCU, and so forth.

### BRIEF DESCRIPTION OF THE DRAWINGS

Embodiment(s) of the present disclosure will be described based on the following figures, wherein:

FIG. 1 is a schematic view of an exemplary vehicle cooling system according to an embodiment;

FIG. 2 is a block diagram illustrating the structure of a control device;

FIG. 3 is a table indicating which of cooling a battery, cooling a PCU, and an air conditioning operation should be conducted with priority, depending on the temperature of a battery and the temperature of coolant to cool the PCU;

FIG. 4 is a table indicating a maximum rotation speed of a compressor in accordance with the temperature of the battery and the temperature of the coolant to cool the PCU;

FIG. 5 is a table indicating a maximum amount of an airflow from an air conditioning system in accordance with the temperature of the battery and the temperature of the coolant to cool the PCU;

FIG. 6 is a table indicating the state of operation of an inside-outside switching door of an air conditioning system in accordance with the temperature of the battery and the temperature of the coolant to cool the PCU; and

FIG. 7 is a table indicating a ratio in amount between refrigerants circulating to cool the battery and to conduct an air-conditioning operation, respectively, in accordance with the temperature of the battery and the temperature of the coolant to cool the PCU.

### DESCRIPTION OF EMBODIMENTS

One example of an embodiment of the present disclosure will now be described in detail. Note that specific shapes, materials, directions, numeric values, and so forth to be mentioned in the description below are only for illustration of examples to facilitate understanding of the present disclosure, and thus can be desirably modified depending on usage, purpose, specifications, and so forth.

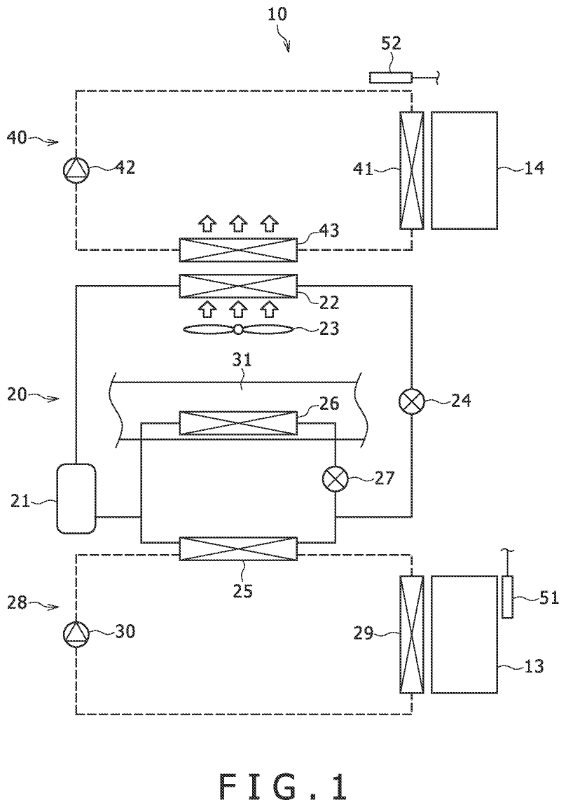

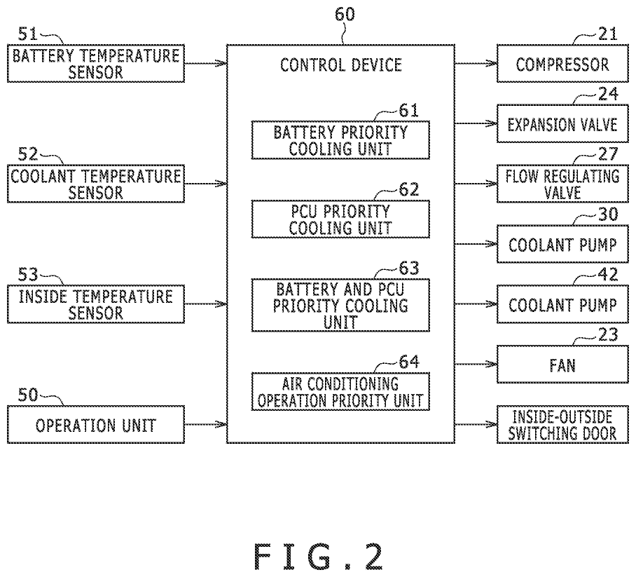

Referring to FIG. 1 and FIG. 2, a vehicle cooling system 10 according to an example of this embodiment will be described. FIG. 1 is a schematic view of the vehicle cooling system 10. FIG. 2 is a block diagram of a control device 60.

The vehicle cooling system 10 is mounted on a vehicle and cools a running battery (hereinafter referred to as a battery) 13 and a running power control unit (hereinafter abbreviated as PCU) 14. The vehicle cooling system 10 also cools the air inside a vehicle cabin in communication with an air path 31 of an air conditioning system (an air conditioning operation).

The vehicle cooling system 10 determines the level of priority in cooling the battery 13, the PCU 14, and the air inside the vehicle cabin, based on the temperature of the battery 13 and the temperature of coolant to cool the PCU 14, as to be described later in detail. This makes it possible to prevent deceleration in the speed of the vehicle due to increased temperature of the battery 13 and to prevent a decrease in the running capability of the vehicle due to restricted output attributed to excessive heating of the PCU 14, or the like.

Although an electric vehicle that charges the battery 13 to run with a motor as a driving force is assumed in this example, this is not an exclusive example. For example, a vehicle that runs with an engine as a power source for running or a hybrid vehicle is applicable.

The vehicle cooling system 10 includes a refrigeration cycle device 20 and a cooling device 40 as illustrated in FIG. 1, and a control device, such as an electronic control unit, or ECU, 60, illustrated in FIG. 2. Specifically, the refrigeration cycle device 20 circulates refrigerant to cool the battery 13 and the air inside the vehicle cabin. The cooling device 40 circulates coolant to cool the PCU 14.

As illustrated in FIG. 1 and FIG. 2, the control device 60 includes an operation unit 50, a battery temperature sensor 51, a coolant temperature sensor 52, and an interior temperature sensor 53. Specifically, the operation unit 50 can adjust at least the temperature set for the interior of the vehicle cabin. The battery temperature sensor 51 determines the temperature of the battery 13. The coolant temperature sensor 52 functions as a power control unit temperature estimation unit for determining the temperature of the coolant to cool the PCU 14. The interior temperature sensor 53 determines the temperature inside the vehicle cabin. Note that the power control unit temperature estimation unit may estimate the temperature of the PCU 14, based on the state of processing by the PCU 14 or an instructed amount given to the PCU 14.

As illustrated in FIG. 1, the refrigeration cycle device 20 includes a vapor compression refrigeration cycle circuit. Specifically, the refrigeration cycle device 20 evaporates refrigerant in a battery heat exchanger 25 provided as a first evaporating unit to cool the battery 13 with a battery cooling unit 29. In addition, the refrigeration cycle device 20 evaporates refrigerant in an evaporator 26 provided as a second evaporating unit disposed parallel to the battery heat exchanger 25 to cool the air passing through the air path 31 of an air conditioning system to be described later to thereby cool the interior of the vehicle cabin.

The refrigeration cycle device 20 includes a compressor 21, a condenser 22, a fan 23, an expansion valve 24, the battery heat exchanger 25, the evaporator 26, and a flow regulating valve 27. Specifically, the compressor 21 compresses refrigerant gas. The condenser 22 condenses the refrigerant gas into liquid refrigerant. The fan 23 supplies air to the condenser 22 and a radiator 43 to be described later. The expansion valve 24 expands the liquid refrigerant. The battery heat exchanger 25 cools the battery 13 with coolant. The evaporator 26 cools the air inside the air path 31 of the air conditioning system to be described later. The flow regulating valve 27 regulates the amount of refrigerant passing through the evaporator 26.

The compressor 21 is driven with a rotary motor, and can change the amount of refrigerant gas to be discharged (outputted) by changing the rotation speed of the rotary motor.

The condenser 22 is a heat exchanger to be cooled with air outside the vehicle, supplied from the fan 23, and condenses refrigerant gas into liquid refrigerant. Downstream, with respect to the airflow, from the fan 23 relative to the condenser 22, the radiator 43 of the cooling device 40 to be described later is disposed.

The battery heat exchanger 25 is connected to a battery cooling circuit 28 that circulates coolant to cool the battery 13. The battery cooling circuit 28 includes the battery cooling unit 29, a coolant pump 30, and the battery heat exchanger 25, and is disposed close to the battery 13. Specifically, the battery cooling unit 29 cools the battery with coolant. The coolant pump 30 circulates the coolant. The battery heat exchanger 25 cools the coolant.

The evaporator 26 is a heat exchanger that constitutes a part of an air conditioning system (not illustrated) in a vehicle cabin. The evaporator 26 is connected parallel to the battery heat exchanger 25. The flow regulating valve 27 is disposed upstream of the evaporator 26.

The air conditioning system includes the air path 31, an inside-outside switching door, the evaporator 26, a heater core, an air mix door, and a blower. Specifically, the air path 31 is used to introduce air cooled or heated into the interior of the vehicle cabin. The inside-outside switching door is used to introduce outside air into the air path 31. The evaporator 26 is disposed on the air path 31 to cool the air passing through the air path 31. The heater core is disposed on the air path 31 to heat the air passing through the air path 31. The air mix door switches between supplying air to the heater core and supplying air to the evaporator 26. The blower generates an airflow toward the inside of the vehicle cabin.

The flow regulating valve 27 regulates the amount of refrigerant passing through the evaporator 26. Specifically, the flow regulating valve 27 can adjust the ratio in amount between refrigerants passing through the evaporator 26 and the battery heat exchanger 25, respectively, in the refrigeration cycle device 20.

The cooling device 40 includes a coolant circuit, and circulates coolant to cool the PCU 14, as described above. The cooling device 40 includes a PCU cooling unit 41 for cooling the PCU 14, a coolant pump 42 for circulating coolant, and the radiator 43 for cooling the coolant, and is disposed close to the PCU 14.

With respect to an airflow from the fan, the radiator 43 is disposed downstream from the condenser 22 constituting a part of the refrigeration cycle device 20, as described above. In other words, the radiator 43 is cooled with air having been supplied from the fan 23 and cooled the condenser 22.

The operation unit 50 is provided inside the vehicle cabin to allow an occupant to conduct at least selection of either a cooling mode or a heating mode of the vehicle cooling system 10, input of a temperature to be set in the vehicle cabin, selection of a defroster mode, and so forth. Information inputted or selected via the operation unit 50 is sent to the control device 60.

The battery temperature sensor 51 is disposed close to the battery 13, and determines the temperature of the battery 13. A detection signal from the battery temperature sensor 51 is sent to the control device 60.

The coolant temperature sensor 52 functioning as a power control unit temperature estimation unit is disposed on a pipe or the like near the PCU cooling unit 41 of the cooling device 40, and determines the temperature of the coolant of the cooling device 40. A detection signal from the coolant temperature sensor 52 is sent to the control device 60. Note that the power control unit temperature estimation unit may estimate the temperature of the PCU 14, based on the state of processing by the PCU 14 or an instructed amount given to the PCU 14, as described above.

The interior temperature sensor 53 is provided inside the vehicle cabin, and determines the temperature inside the vehicle cabin. A detection signal from the interior temperature sensor 53 is sent to the control device 60.

In the vehicle cooling system 10 in this example, for example, enhancement of the cooling capability to cool the battery 13 requires an increase in the amount of refrigerant passing through the battery heat exchanger 25. In this case, the amount of refrigerant passing through the evaporator 26 decreases, so that the cooling capability of the air conditioning system decreases.

Similarly, enhancement of the cooling capability to cool the battery 13 requires an increase in the amount of refrigerant circulating through the entire refrigeration cycle device 20. In this case, the condensation temperature of the condenser 22 increases, and so does the temperature of the air having passed through the condenser 22. This decreases the cooling capability to cool the radiator 43, so that the cooling capability to cool the PCU 14 decreases.

In the vehicle cooling system 10 in this example, enhancement of the cooling capability to cool the PCU 14 requires a decrease in the temperature of the air having passed through the condenser 22 of the refrigeration cycle device 20, in order to enhance the cooling capability to cool the radiator 43. This in turn requires a decrease in the amount of refrigerant circulating through the refrigeration cycle device 20, in order to lower the condensation temperature of the condenser 22. In this case, the cooling capability of the refrigeration cycle device 20 decreases, so that the cooling capability to cool the battery 13 and the cooling capability of the air conditioning system decrease.

In the vehicle cooling system 10 in this example, for example, enhancement of the cooling capability of the air conditioning system requires an increase in the amount of refrigerant passing through the evaporator 26. In this case, the amount of refrigerant passing through the battery heat exchanger 25 decreases, so that the cooling capability to cool the battery 13 decreases.

Similarly, enhancement of the cooling capability of the air conditioning system requires an increase in the amount of refrigerant circulating through the entire refrigeration cycle device 20. In this case, the condensation temperature of the condenser 22 increases, which increases the temperature of the air having passed through the condenser 22. Accordingly, the cooling capability to cool the radiator 43 decreases, so that the cooling capability to cool the PCU 14 decreases.

In view of the above, the vehicle cooling system 10 in this example determines which of cooling the battery 13, cooling the PCU 14, and the air conditioning operation of an air conditioning system should be conducted with priority, based on the temperature of the battery 13 and the temperature of the coolant to cool the PCU 14, and controls the refrigeration cycle device 20 and the cooling device 40 to thereby enhance cooling capability relevant to the determined operation to be conducted with priority, as to be described later in detail.

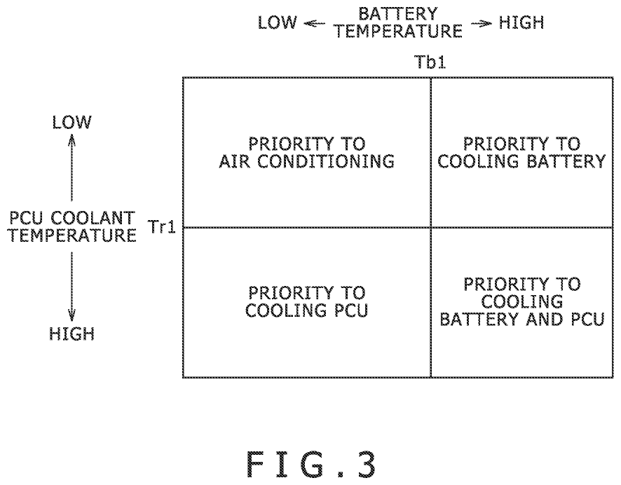

Referring to FIG. 2 and FIG. 3, the structure of the control device 60 will now be described. FIG. 3 is a table indicating which of cooling the battery 13, cooling the PCU 14, and the air conditioning operation of the air conditioning system should be conducted with priority, depending on the temperature of the battery 13 and the temperature of the coolant to cool the PCU 14.

The control device 60 includes an operation unit, such as a Central Processing Unit (CPU); and a memory unit, such as a Random Access Memory (RAM), a Read Only Memory (ROM), or the like, and executes signal processing according to a program stored beforehand in the ROM, using the temporary storage function of the RAM.

The control device 60 is connected to the operation unit 50, the battery temperature sensor 51, the coolant temperature sensor 52, and the interior temperature sensor 53, or the like, to receive signals sent from these units. In addition, the control device 60 is connected to the compressor 21, fan 23, expansion valve 24, and flow regulating valve 27 of the refrigeration cycle device 20, the coolant pump 30 of the battery cooling circuit 28, and a circuit of the coolant pump 42 of the cooling device 40, or the like, to send signals to these respective units.

The control device 60 includes a battery priority cooling unit 61, a PCU priority cooling unit 62, a battery and PCU priority cooling unit 63, and an air conditioning operation priority unit 64. Specifically, the battery priority cooling unit 61 cools the battery 13 with priority. The PCU priority cooling unit 62 cools the PCU 14 with priority. The battery and PCU priority cooling unit 63 cools the battery 13 and the PCU 14 with priority. The air conditioning operation priority unit 64 conducts the air conditioning operation of the air conditioning system with priority.

As illustrated in FIG. 3, the battery priority cooling unit 61 has a function of increasing the amount of refrigerant passing through the battery heat exchanger 25 to thereby enhance the cooling capability to cool the battery 13 with priority when the temperature of the battery 13 is equal to or higher than a first predetermined temperature Tb1 (for example, 51° C.) and the temperature of the coolant is less than a first predetermined temperature Tr1 (for example, 61° C.).

Specifically, for example, the battery priority cooling unit 61 applies control, for example, by increasing the rotation speed of the compressor 21 of the refrigeration cycle device 20 or increasing the amount of refrigerant passing through the battery heat exchanger 25 through adjustment with the flow regulating valve 27 of the refrigeration cycle device 20, and so forth.

This control enables enhancement of the cooling capability to cool the battery 13, thus preventing deceleration of the running speed of the vehicle due to increased temperature of the battery 13.

As illustrated in FIG. 3, the PCU priority cooling unit 62 has a function of decreasing the amount of refrigerant circulating through the refrigeration cycle device 20 to thereby enhance the cooling capability to cool the PCU 14 with priority when the temperature of the battery 13 is less than the first predetermined temperature Tb1 and the temperature of the coolant is equal to or higher than the first predetermined temperature Tr1.

Specifically, for example, the PCU priority cooling unit 62 applies control, for example, by decreasing the rotation speed of the compressor 21 of the refrigeration cycle device 20, by decreasing the rotation speed of the blower of the air conditioning system for introducing air into the vehicle cabin to thereby decrease the amount of air to be introduced into the vehicle cabin, or by fully closing the inside-outside switching door of the air conditioning system upon detection of high outside temperature to thereby decrease a cooling load in cooling the vehicle cabin, or the like.

Such control enables enhancement of the cooling capability to cool the PCU 14. Consequently, it is possible to prevent a decrease in the running capability of the vehicle due to restricted output from a drive motor or the like attributed to excessive heating of the PCU 14. Further, as it is possible to enhance the cooling capability to cool the PCU 14 without changing the capacities of the PCU cooling unit 41 and the radiator 43 of the cooling device 40, the radiator 43 in this embodiment can have a smaller capacity than that of a currently available typical radiator.

As illustrated in FIG. 3, the battery and PCU priority cooling unit 63 has a function of adjusting an output from the refrigeration cycle device 20 in such a manner that enables cooling of both the battery 13 and the PCU 14 when the temperature of the battery 13 is equal to or higher than the first predetermined temperature Tb1 and the temperature of the coolant is equal to or higher than the first predetermined temperature Tr1.

As illustrated in FIG. 3, the air conditioning operation priority unit 64 has a function of increasing the amount of refrigerant passing through the evaporator 26 to thereby enhance the cooling capability of the air conditioning system with priority when the temperature of the battery 13 is less than the first predetermined temperature Tb1 and the temperature of the coolant is less than the first predetermined temperature Tr1.

Specifically, for example, the air conditioning operation priority unit 64 applies control, for example, by increasing the rotation speed of the compressor 21 of the refrigeration cycle device 20 or by increasing the amount of refrigerant passing through the evaporator 26 through adjustment with the flow regulating valve 27 of the refrigeration cycle device 20, or the like.

Such control enables enhancement of the cooling capability to cool the air inside the vehicle cabin. In other words, it is possible to satisfy comfortability of an occupant when there is no need to enhance the cooling capability to cool the battery 13 or the PCU 14.

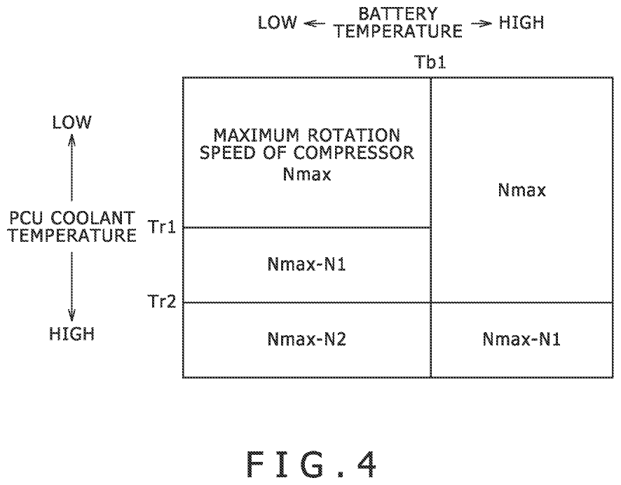

Referring to FIG. 4, cooling control according to one example of this embodiment will be described. FIG. 4 is a table indicating a maximum rotation speed of the compressor 21 of the refrigeration cycle device 20 in accordance with the temperature of the battery 13 and the temperature of the coolant to cool the PCU 14.

In this example, which of cooling the battery 13, cooling the PCU 14, and the air conditioning operation should be conducted with priority is determined, based on the temperature of the battery 13 and the temperature of the coolant, and the maximum rotation speed of the compressor 21 of the refrigeration cycle device 20 is then changed so as to enhance cooling capability relevant to the determined operation to be conducted with priority. Assume below that the maximum rotation speed Nmax (for example, 8000 rpm) of the compressor 21 in a normal operation is set.

As illustrated in FIG. 4, in the case where the temperature of the battery 13 is equal to or higher than the first predetermined temperature Tb1 (for example, 51° C.), the maximum rotation speed Nmax of the compressor 21 is maintained in order to enhance the cooling capability to cool the battery 13 with priority. With this arrangement, the amount of refrigerant circulating through the entire refrigeration cycle device 20 is tolerated up to the maximum amount for circulation at the maximum rotation speed Nmax of the compressor 21. Accordingly, the amount of refrigerant passing through the battery heat exchanger 25 increases, to thereby enhance the cooling capability to cool the battery 13.

In the above, in the case where the temperature of the coolant is equal to or higher than a second predetermined temperature Tr2 (for example, 64° C.), the maximum rotation speed of the compressor 21 is decreased by an amount N1 (for example, 2000 rpm) as the PCU 14 as well needs to be cooled, although cooling the battery 13 is still prioritized. In other words, in the case where the temperature of the battery 13 is equal to or higher than the first predetermined temperature Tb1, and the temperature of the coolant is equal to or higher than the second predetermined temperature Tr2, the maximum rotation speed of the compressor 21 is set to Nmax-N1 or greater in order to cool both the battery 13 and the PCU 14.

In the case where the temperature of the battery 13 is less than the first predetermined temperature Tb1 and the temperature of the coolant is equal to or higher than the second predetermined temperature Tr2, the maximum rotation speed of the compressor 21 is set to a speed slower by an amount N2 (for example, 3000 rpm) in order to enhance the cooling capability to cool the PCU 14 with priority.

With this arrangement, the amount of refrigerant circulating through the refrigeration cycle device 20 decreases to a predetermined amount or less for circulation that is less than the maximum amount of the circulating refrigerant. Accordingly, the condensation temperature of the condenser 22 lowers, and so does the temperature of the air having passed through the condenser 22. This enhances the cooling capability to cool the radiator 43, thereby enhancing the cooling capability of the cooling device 40, which in turn enhances the cooling capability to cool the PCU 14.

In the case where the temperature of the battery 13 is less than the first predetermined temperature Tb1, and the temperature of the coolant is less than the first predetermined temperature Tr1, the maximum rotation speed Nmax of the compressor 21 is maintained in order to enhance the cooling capability of the air conditioning system with priority. With this arrangement, the amount of refrigerant circulating through the entire refrigeration cycle device 20 is tolerated up to the maximum amount for circulation at the maximum rotation speed Nmax of the compressor 21. Accordingly, the amount of refrigerant passing through the evaporator 26 increases, thereby enhancing the cooling capability to cool the air inside the vehicle cabin.

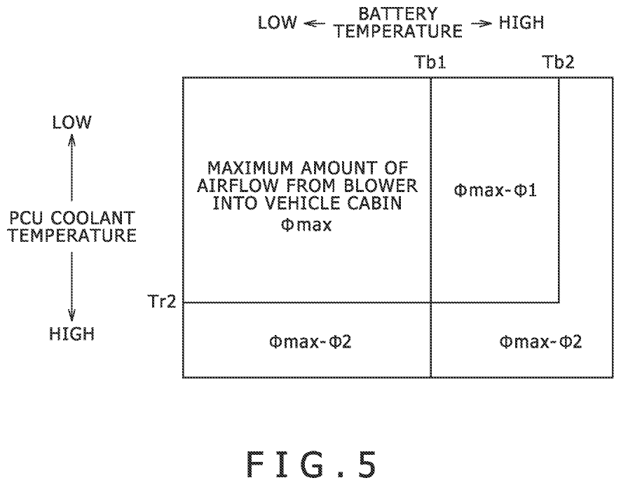

Referring to FIG. 5, cooling control according to another example of the embodiment will now be described. FIG. 5 is a table indicating a maximum amount of air to be introduced into the vehicle cabin from the blower of the air conditioning system in accordance with the temperature of the battery 13 and the temperature of the coolant to cool the PCU 14.

In this example, which of cooling the battery 13, cooling the PCU 14, and the air conditioning operation should be conducted with priority is determined, based on the temperature of the battery 13 and the temperature of the coolant to cool the PCU 14, and the maximum amount of air to be supplied from the blower of the air conditioning system is changed to thereby enhance the cooling capability relevant to the determined operation to be conducted with priority. Assume below that the maximum amount Φmax (for example, 460 m³/h) of air to be supplied from the blower in the air conditioning operation of the air conditioning system is set.

As illustrated in FIG. 5, in the case where the temperature of the battery 13 is equal to or higher than the first predetermined temperature Tb1 (for example, 51° C.), the amount of air to be supplied from the blower is set to an amount less than the maximum amount Φmax by an amount Φ1 (for example, 30 m³/h) in order to enhance the cooling capability to cool the battery 13 with priority. Similarly, in the case where the temperature of the battery 13 is equal to or higher than a second predetermined temperature Tb2 (for example, 54° C.), the amount of air to be supplied from the blower is set to an amount less than the maximum amount Φmax by an amount Φ2 (for example, 60 m³/h).

With this arrangement, the amount of refrigerant passing through the evaporator 26 decreases to a predetermined amount or less for circulation that is less than the amount of refrigerant passing through the evaporator 26 at the time when the maximum amount Φmax of air is supplied from the blower. This increases the amount of refrigerant passing through the battery heat exchanger 25, thereby enhancing the cooling capability to cool the battery 13.

In the case where the temperature of the battery 13 is less than the first predetermined temperature Tb1 and the temperature of the coolant of the PCU 14 is equal to or higher than the second predetermined temperature Tr2 (for example, 64° C.), the amount of air to be supplied from the blower is set to an amount less than the maximum amount Φmax by an amount Φ2 in order to enhance the cooling capability to cool the PCU 14 with priority over the battery 13 and the air inside the vehicle cabin.

With this arrangement, the amount of refrigerant circulating through the refrigeration cycle device 20 decreases to a predetermined amount or less for circulation that is less than the amount of refrigerant circulating through the refrigeration cycle device 20 at the time when the maximum amount Φmax of air is supplied from the blower. This decreases the condensation temperature of the condenser 22 and thus the temperature of the air having passed through the condenser 22. This enhances the cooling capability to cool the radiator 43, to thereby enhance the cooling capability of the cooling device 40, and in turn enhancing the cooling capability to cool the PCU 14.

In the case where the temperature of the battery 13 is less than the first predetermined temperature Tb1 and the temperature of the coolant is less than the second predetermined temperature Tr2, the maximum amount Φmax of air from the blower is maintained in order to enhance the cooling capability of the air conditioning system with priority. With this arrangement, the amount of refrigerant passing through the evaporator 26 is tolerated up to a predetermined amount for circulation, so that the cooling capability to cool the air inside the vehicle cabin is enhanced.

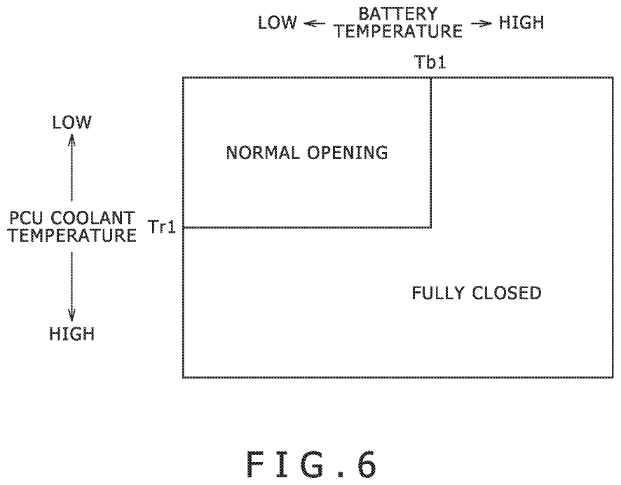

Referring to FIG. 6, cooling control according to another example of an embodiment will be described. FIG. 6 is a table indicating the state of operation of the inside-outside switching door of the air path 31 of the air conditioning system in accordance with the temperature of the battery 13 and the temperature of the coolant to cool the PCU 14.

In this example, which of cooling the battery 13, cooling the PCU 14, and the air conditioning operation should be conducted with priority is determined, based on the temperature of the battery 13 and the temperature of the coolant to cool the PCU 14, and the degree of opening of the inside-outside switching door of the air path 31 of the air conditioning system is then controlled so as to enhance the cooling capability relevant to the determined operation to be conducted with priority. This embodiment is effective when the temperature of the air outside the vehicle is higher than that of the air inside the vehicle cabin.

As illustrated in FIG. 6, in the case where the temperature of the battery 13 is equal to or higher than the first predetermined temperature Tb1 (for example, 51° C.) or in the case where the temperature of the coolant is equal to or higher than the first predetermined temperature Tr1 (for example, 61° C.), the inside-outside switching door is fully closed to shut off introduction of the outside air into the vehicle cabin.

With this arrangement, a cooling load in cooling the air inside the vehicle cabin decreases. Accordingly, the amount of refrigerant passing through the evaporator 26 decreases, while the amount of refrigerant passing through the battery heat exchanger 25 increases. This enhances cooling capability to cool the battery 13. Meanwhile, the amount of refrigerant circulating through the entire refrigeration cycle device 20 decreases, which decreases the condensation temperature of the condenser 22. Accordingly, the temperature of the air having passed through the condenser 22 lowers, thereby enhancing the cooling capability to cool the radiator 43. Hence, the cooling capability to cool the cooling device 40 is enhanced, thereby enhancing the cooling capability to cool the PCU 14.

In the case where the temperature of the battery 13 is less than the first predetermined temperature Tb1, and the temperature of the coolant is less than the first predetermined temperature Tr1, the degree of opening of the inside-outside switching door is normally adjustable.

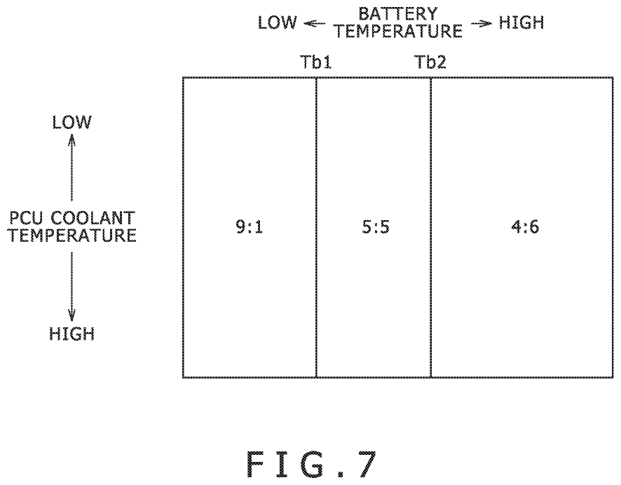

Referring to FIG. 7, cooling control according to another example of the embodiment will now be described. FIG. 7 is a table indicating a ratio in amount between refrigerants passing through the evaporator 26 and the battery heat exchanger 25, respectively, based on the temperature of the battery 13 and the temperature of the coolant to cool the PCU 14. Note that the ratio is adjusted with the flow regulating valve 27.

In this example, which of cooling the battery 13, cooling the PCU 14, and the air conditioning operation should be conducted with priority is determined, based on the temperature of the battery 13 and the temperature of the coolant to cool the PCU 14, and the flow regulating valve 27 is then controlled so as to enhance the cooling capability relevant to the determined operation to be conducted with priority.

As illustrated in FIG. 7, in the case where the temperature of the battery 13 is equal to or higher than the second predetermined temperature Tb2 (for example, 51° C.), the flow regulating valve 27 is adjusted such that the ratio in amount between the refrigerants passing through the evaporator 26 and the battery heat exchanger 25, respectively, is set to 4:6; in other words, such that a larger amount of refrigerant passes through the battery heat exchanger 25 than through the evaporator 26. This arrangement increases the amount of refrigerant passing through the battery heat exchanger 25, thereby enhancing the cooling capability to cool the battery 13.

As illustrated in FIG. 7, in the case where the temperature of the battery 13 is less than the second predetermined temperature Tb2 (for example, 51° C.) and equal to or higher than the first predetermined temperature Tb1 (for example, 47° C.), the flow regulating valve 27 is adjusted such that the ratio in amount between the refrigerants passing through the evaporator 26 and the battery heat exchanger 25, respectively, is set to 5:5; in other words, such that the same amount of refrigerants pass through the battery heat exchanger 25 and the evaporator 26, respectively. This arrangement enables cooling of both the battery 13 and the air inside the vehicle cabin.

As illustrated in FIG. 7, in the case where the temperature of the battery 13 is less than the first predetermined temperature Tb1 (for example, 47° C.), the flow regulating valve 27 is adjusted such that the ratio in amount between refrigerants passing through the evaporator 26 and the battery heat exchanger 25, respectively, is set to 9:1; in other words, such that a larger amount of refrigerant passes through the evaporator 26 than through the battery heat exchanger 25. This arrangement increases the amount of refrigerant passing through the evaporator 26, thereby enhancing the cooling capability to cool the air inside the vehicle cabin.

Note that the present disclosure is not limited to the above-described embodiment and its modified examples, and may be adapted to various modifications and improvements without departing from the scope defined in the following claims.

For example, the radiator 43 in this embodiment may be replaced with an air-cooling oil cooler or an intercooler of an inlet pipe, which may be disposed downstream, with respect to the airflow, from the condenser 22 of the refrigeration cycle device 20 to thereby implement the above-described cooling control.

1. A vehicle cooling system, comprising:
a refrigeration cycle device including
a first evaporating unit for cooling a running battery of a vehicle,
a second evaporating unit connected parallel to the first evaporating unit, the second evaporating unit being for cooling air inside a vehicle cabin,
a regulating valve for adjusting a ratio in amount between refrigerant passing through the first evaporating unit and refrigerant passing through the second evaporating unit, and
a condenser for being cooled with airflow;
a cooling device for cooling a power control unit of the vehicle with coolant, the cooling device including a heat exchanger disposed downstream from the condenser with respect to the airflow, the heat exchanger being for cooling the coolant with the airflow; and
a power control unit temperature estimation unit for estimating temperature of the power control unit,
wherein
in a case where the temperature of the battery is equal to or higher a predetermined temperature, the battery is cooled with priority,
in a case where the temperature of the power control unit, estimated by the power control unit temperature estimation unit, is equal to or higher than another predetermined temperature, the power control unit is cooled with priority, and
in a case where the temperature of the battery is less than the predetermined temperature and the temperature of the power control unit, estimated by the power control unit temperature estimation unit, is less than the other predetermined temperature, the air inside the vehicle cabin is cooled with priority.

2. The vehicle cooling system according to claim 1, wherein in a case where the battery is cooled with priority, an amount of refrigerant circulating through the refrigeration cycle device is increased, and an amount of refrigerant passing through the first evaporating unit is increased with the regulating valve.

3. The vehicle cooling system according to claim 1, wherein in a case where the power control unit is cooled with priority, an amount of refrigerant passing through the condenser is decreased to thereby lower the temperature of the airflow having passed through the condenser.

4. The vehicle cooling system according to claim 1, wherein in a case where the air inside the vehicle cabin is cooled with priority, the amount of refrigerant circulating through the refrigeration cycle device is increased and an amount of refrigerant passing through the second evaporating unit is increased with the regulating valve.

5. The vehicle cooling system according to claim 2, wherein in a case where the power control unit is cooled with priority, an amount of refrigerant passing through the condenser is decreased to thereby lower the temperature of the airflow having passed through the condenser.

6. The vehicle cooling system according to claim 2, wherein in a case where the air inside the vehicle cabin is cooled with priority, the amount of refrigerant circulating through the refrigeration cycle device is increased and an amount of refrigerant passing through the second evaporating unit is increased with the regulating valve.

7. The vehicle cooling system according to claim 3, wherein in a case where the air inside the vehicle cabin is cooled with priority, the amount of refrigerant circulating through the refrigeration cycle device is increased and an amount of refrigerant passing through the second evaporating unit is increased with the regulating valve.

8. The vehicle cooling system according to claim 5, wherein in a case where the air inside the vehicle cabin is cooled with priority, the amount of refrigerant circulating through the refrigeration cycle device is increased and an amount of refrigerant passing through the second evaporating unit is increased with the regulating valve.
